(19) United States
(12) Patent Application Publication
(10) Pub. No.: US 2007/0254562 A1
(43) Pub. Date: Nov. 1, 2007

(54) Magnetic Disk Substrate and Production Method of Magnetic Disk

(75) Inventors: Hiroyuki Machida, Chiba (JP); Katsuaki Aida, Chiba (JP); Kazuyuki Haneda, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/661,432

(22) PCT Filed: Aug. 26, 2005
(86) PCT No.: PCT/JP05/16054

§ 371 Date: Feb. 28, 2007

Related U.S. Application Data
(60) Provisional application No. 60/607,305, filed on Sep. 7, 2004.

(30) Foreign Application Priority Data
Aug. 30, 2004 (JP) 2004-250445

(51) Int. Cl. B24B 1/00; G11B 5/82

(52) U.S. Cl. 451/41; 360/135

(57) ABSTRACT

The invention can provides a production method of a magnetic disk substrate capable of controlling surface roughness and can reduce surface defects using only a polishing step, and a production method of a magnetic disk. When a glass substrate is polished, the glass substrate polished is with abrasive slurry containing abrasives. Next, the glass substrate is further polished with an aqueous rinse solution not containing the abrasives so that the surface roughness Ra of the glass substrate is 4 to 8 Å.

### CROSS-REFERENCES TO RELATED APPLICATIONS

This application is an application filed under 35 U.S.C. §111(a) claiming benefit pursuant to 35 U.S.C. §119(e) of the filing date of Provisional Application No. 60/607,305, filed Sep. 7, 2004, pursuant to 35 U.S.C. §111(b).

### TECHNICAL FIELD

This invention relates to a magnetic disk substrate and a production method of a magnetic disk.

### BACKGROUND ART

Magnetic disk devices have made remarkable progress, as external storage devices of computers, owing to their superior cost-performance ratio and further growth is expected. An aluminum type substrate has been used in the past as a substrate of a magnetic disk which is mounted to the magnetic disk device, but glass substrates, made of materials such as chemical tempered glass and crystallized glass, have gradually gained wider application because they have high impact resistance and have been flatness. In other words, the aluminum type substrate can easily provide a magnetic disk having excellent magnetic characteristics but involves the problem of flatness because it can be plastically deformed during a mechanical process such as polishing. In contrast, the glass substrate can be very flat because it has high surface hardness and does not suffer plastic deformation as described above.

Control of surface roughness of these glass substrates, in order to reduce variance of Read-Write Performance of magnetic disks, has been the problem in the past. Various studies have been made to solve this problem. For example, a method that conducts surface treatment by using hydrofluoric acid, etc., after polishing and then chemical tempering treatment (Japanese Unexamined Patent Publication (Kokai) No. 2003-36522), a method that causes a polishing material to contain at least 60 mass % of cerium oxide and conducts chemical tempering treatment after polishing (Japanese Unexamined Patent Publication (Kokai) No. 2001-167430) and a method that forms an electrically conductive film having specific surface roughness on the glass substrate (Japanese Unexamined Patent Publication (Kokai) No. 2003-217111) have been proposed.

### DISCLOSURE OF THE INVENTION

The invention provides a production method of a magnetic disk substrate and a production method of a magnetic disk that can control the surface roughness, using only a polishing step, and can reduce surface defects.

The present invention provides the following inventions to solve the problems described above.
(1) A production method of a magnetic disk substrate, by polishing a glass substrate, characterized in that the glass substrate is polished with polishing slurry containing abrasives and is further polished with an aqueous rinsing solution not containing abrasives so that a surface roughness Ra of said glass substrate is 4 to 8 Å.
(2) The production method of a magnetic disk substrate as described in (1), wherein the surface roughness Ra is 4.5 to 7.5 Å.
(3) The production method of a magnetic disk substrate as described in (1), wherein the polishing slurry containing abrasives contains cerium oxide.
(4) The production method of a magnetic disk substrate as described in (2), wherein said aqueous slurry containing the abrasives contains cerium oxide.
(5) The production method of a magnetic disk substrate as described in any of (1) through (4), wherein the aqueous rinsing solution not containing the abrasives is water.
(6) The production method of a magnetic disk substrate as described in any of (1) through (4), wherein the aqueous rinsing solution not containing the abrasives contains a surfactant.
(7) The production method of a magnetic disk substrate as described in any of (1) through (4), wherein polishing by the aqueous rinsing solution not containing the abrasives is conducted at a number of revolutions of the plate of 5 to 50 rpm and a processing pressure of 5 to 50 g/cm² (about 490 to about 4,903 Pa).
(8) The production method of a magnetic disk substrate as described in (7), wherein the polishing time with the aqueous rinsing solution not containing the abrasives is 0.5 to 10 minutes.
(9) A production method of a magnetic disk characterized in that a magnetic recording layer is formed on the magnetic disk substrate as described in any of (1) through (8).
(10) A magnetic disk substrate for a magnetic disk, produced by a production method described in any of (1) through (8).

The invention can control the surface roughness of a magnetic disk substrate by only a polishing step and can reduce surface defects. Therefore, the invention can simplify a production process and can improve productivity. Further, the invention can improve the yield and the reliability of magnetic disks.

### BEST MODE FOR CARRYING OUT THE INVENTION

When a surface of a glass substrate is polished in the production method of the magnetic disk substrate according to the invention, the glass substrate is polished with a polishing solution containing abrasives and is further polished with an aqueous rinsing solution not containing the abrasives so that the surface roughness Ra of the glass substrate is 4 to 8 Å.

Amorphous, chemical tempered or crystallized glass that has generally been used for the magnetic disk substrates can be used as the glass substrate in the invention. Examples are glasses such as soda lime, aluminosilicate, lithium silicate, lithium aluminosilicate, aluminoborosilicate, and so forth. As the chemical tempered glass, glass that is brought into contact with a molten salt at a high temperature to cause ion exchange of alkali ions in the glass with different kinds of alkali ions in the molten salt and is tempered by the compressive stress is suitable. Examples of the crystallized glass are those which are obtained by re-heating glass under a controlled condition and precipitating and growing a large number of fine crystals. Concrete examples are an Al₂O₃-SiO₂-Li₂O type, a B₂O₃-Al₂O₃-SiO₂-Li₂O type, and so forth. The thickness of such glass substrates is generally selected from the range of about 0.1 to about 2 mm.

Polishing of the surface of the glass substrate in the invention can be carried out by abrading the glass substrate surface with a plate by using a polishing carrier. First, the glass substrate is polished with polishing slurry prepared by dispersing abrasives in water, or the like. This polishing is generally carried out at a number of revolutions of the plate of 10 to 50 rpm and a processing pressure of 50 to 100 g/cm² (about 4,903 to about 9,806 Pa) for 20 to 50 minutes until the surface roughness Ra of the glass substrate attains generally 10 Å or below, preferably close to 8 Å. Examples of the abrasives are generally cerium oxide, zirconium oxide, silicon dioxide, etc, but cerium oxide is suitable from the aspect of the polishing speed.

In the invention, polishing is further carried out by using an aqueous rinsing solution not containing abrasives so that the surface roughness Ra of the glass substrate is 4 to 8 Å. It is preferred in this case to continue polishing by switching the supply of the polishing slurry containing the abrasives to the aqueous rinsing solution not containing the abrasives. Polishing with this aqueous rinsing solution not containing the abrasives is suitably carried out at a number of revolutions of the plate of 5 to 50 rpm and a processing pressure of 10 to 30 g/cm² (about 980 to about 2,942 Pa). The polishing time is suitably about 1 to about 10 minutes.

Examples of the aqueous rinsing solution not containing the abrasives are water, water containing a surfactant, and so forth. The surfactant may be any of a cationic type such as alkyl pyridinium salts, alkyl trimethylammonium salts, etc; an anionic type such as alkyl benzenesulfonates, soap, etc; and a nonionic type such as alkyl polyoxyethylene ether aliphatic acid polyhydric alcohol esters. Polishing is stopped when the surface roughness Ra of the glass substrate reaches 4 to 8 Å, preferably 4.5 to 7.5 Å and further preferably 5 to 7 Å, by polishing with the aqueous rinsing solution.

The polishing carrier used in the invention is suitably the one that has an inner surface capable of coming into contact with an outer end face of the glass substrate and coated with a resin because it can reduce the occurrence of scratches of the outer end face of the glass substrate.

The resin used for resin coating is a thermoplastic resin such as a polyester, polyamide, polyolefin, ABS or polystyrene resin or a thermosetting resin such as an epoxy, phenol, unsaturated polyester or polyimide resin, but the epoxy resin is most suitable. Preferably, these resins are not fiber reinforced. The thickness of the resin coating is selected from the range of about 10 μm to about 1 mm.

The resulting magnetic disk substrate is washed and dried in a customary manner after polishing and is used for the production of a magnetic disk. For example, texturing for forming texture grooves in a head traveling direction is first applied to the substrate, whenever necessary. Next, a base film made of a Cr alloy is formed by sputtering on this substrate. A magnetic recording layer made of a Co base alloy is formed to a thickness of about 10 to 100 nm on this base film, for example. A protective film of carbon, or the like, is preferably formed further on this magnetic recording layer to improve corrosion resistance, sliding resistance, etc. Hydrogenated carbon is formed, by sputtering of diamond-like carbon by CVD, for example, to a film thickness of about 1 to about 50 nm as carbon. Perfluoropolyether or a product obtained by esterifying or amidating the terminals of the former is diluted with a solvent and is applied by spraying, dipping, spin coating, etc, to a film thickness of about 0.5 to 5 nm and as a lubrication layer, to the surface of this carbon protective film, and the durability, the reliability, etc., can be further improved.

When the magnetic disk is produced by using the magnetic disk glass substrate acquired by the method of the invention, the surface roughness of the magnetic disk substrate can be controlled by only the polishing step and the surface defects can be reduced. Therefore, the production process can be simplified and productivity can be improved. Variance of the Read-Write Performance can be reduced and production yield and reliability of the magnetic disk can be improved.

Though the invention will be explained in further detail with reference to Examples thereof, the invention is not limited to these Examples unless the invention exceeds the gist thereof.

In the Examples, measurement of surface defects of glass substrates were carried out in the following way. The top and bottom surface (total 20 surfaces) of 10 arbitrary test pieces (glass substrates) obtained under each condition were measured and the quotient obtained by dividing the total number of defects on each surface by the number of measurement surfaces was used as the number of surface defects. The measurement was conducted by using an optical surface inspection apparatus (produced by Hitachi High Technologies, Co.).

The measurement of the surface roughness was conducted by using an atomic force microscope (AFM) (produced by Digital Instruments, Inc.).

### Example 1

A 2.5-in. lithium silicate type crystallized glass substrate was polished. In the polishing, cerium oxide abrasive slurry (cerium oxide concentration 10 mass %-water) was supplied and polishing was carried out at a number of revolutions of a plate of 35 rpm and a processing pressure of 80 g/cm² (about 7,844 Pa) for 40 minutes. Next, water was supplied in place of the cerium type polishing solution and aqueous rinse polishing was carried out at a number of revolutions of the plate of 15 rpm and a processing pressure of 10 g/cm² (about 980 Pa) for 2 minutes. After washing, the glass substrate was dried. The surface roughness Ra of the resulting glass substrate was 7.1 Å. On the resulting glass substrate were formed, serially by sputtering and at a substrate temperature of 200° C., a Cr film as a base layer to a thickness of 60 nm, a Co₁₃Cr₆Pt₃Ta alloy film as a magnetic recording layer to 20 nm and a diamond-like carbon film as a protective layer to 10 nm. Furthermore, a perfluoropolyether lubrication layer was applied by spraying to a thickness of 3 nm, giving a magnetic disk. Read-Write Performance (S/N ratio) of this magnetic disk were a reference disk (Ref)+0.09 [dB].

### Example 2

A glass substrate and a magnetic disk were produced in the same way as in Example 1 with the exception that the processing pressure of aqueous rinse polishing was changed to 20 g/cm² (about 1,960 Pa). The surface roughness Ra of the resulting glass substrate was 6.2 Å. The number of surface detects was decreased from 7.8 defects before aqueous rinse polishing to 5.1 defects.

The Read-Write Performance of the resulting magnetic disk (S/N ratio) were Ref+0.24 [dB].

### Example 3

A glass substrate and a magnetic disk were produced in the same way as in Example 1 with the exception that the processing pressure of aqueous rinse polishing was changed to 25 g/cm² (about 2,450 Pa). The surface roughness Ra of the resulting glass substrate was 5.6 Å. The Read-Write Performance (S/N ratio) of the resulting magnetic disk were Ref+0.31 [dB].

### Example 4

A glass substrate and a magnetic disk were produced in the same way as in Example 1 with the exception that the processing pressure of aqueous rinse polishing was changed to 30 g/cm² (about 2,942 Pa). The surface roughness Ra of the resulting glass substrate was 5.0 Å. The Read-Write Performance (S/N ratio) of the resulting magnetic disk were Ref+0.36 [dB].

### INDUSTRIAL APPLICABILITY

The invention can control the surface roughness of the magnetic disk by only the polishing step and can reduce the surface defects. Therefore, the invention can simplify the production process and can improve productivity. The invention can reduce variance in the Read-Write Performance of the magnetic disk.

1. A production method of a magnetic disk substrate by polishing a glass substrate, characterized in that said glass substrate is polished with polishing slurry containing abrasives and is further polished with an aqueous rinsing solution not containing abrasives so that a surface roughness Ra of said glass substrate is 4 to 8 Å.

2. The production method of a magnetic disk substrate according to claim 1, wherein the surface roughness Ra is 4.5 to 7.5 Å.

3. The production method of a magnetic disk substrate according to claim 1, wherein said aqueous slurry containing the abrasives contains cerium oxide.

4. The production method of a magnetic disk substrate according to claim 2, wherein said aqueous slurry containing the abrasives contains cerium oxide.

5. The production method of a magnetic disk substrate according to claim 1, wherein said aqueous rinsing solution not containing the abrasives is water.

6. The production method of a magnetic disk substrate according to claim 1, wherein said aqueous rinsing solution not containing the abrasives contains a surfactant.

7. The production method of a magnetic disk substrate according to claim 1, wherein polishing with said aqueous rinsing solution not containing the abrasives is conducted at a number of revolutions of plate of 5 to 50 rpm and a processing pressure of 5 to 50 g/cm² (about 490 to about 4,903 Pa).

8. The production method of a magnetic disk substrate according to claim 7, wherein the polishing time with said aqueous rinsing solution not containing the abrasives is 0.5 to 10 minutes.

9. A production method of a magnetic disk characterized in that a magnetic recording layer is formed on said magnetic disk substrate according to claim 1.

10. A magnetic disk substrate for a magnetic disk, produced by a production method according to claim 1.
